(19) United States
(12) Patent Application Publication
(10) Pub. No.: US 2024/0404009 A1
(43) Pub. Date: Dec. 5, 2024

(54) FOVEATED DISPLAY IMAGE ENHANCEMENT SYSTEMS AND METHODS

(71) Applicant: Apple Inc., Cupertino, CA (US)

(72) Inventors: Yun Gong, Cupertino, CA (US); Jim C. Chou, San Jose, CA (US); Guy Cote, Aptos, CA (US); Haiyan He, Saratoga, CA (US); Michael J. Rockwell, Palo Alto, CA (US)

(21) Appl. No.: 18/326,630

(22) Filed: May 31, 2023

(51) Int. Cl. G06T 5/20; G06F 3/01; G06T 5/50; G06T 7/13; G06T 11/00; G09G 3/20

(52) U.S. Cl. CPC G06T 5/20; G06F 3/013; G06T 5/50; G06T 7/13; G06T 11/00; G09G 3/2096; G06T 2207/10024; G06T 2207/20192; G06T 2207/20221; G09G 2340/0407; G09G 2340/10; G09G 2354/00

(57) ABSTRACT

A system may include a display for displaying an image frame that is divided into regions having respective resolutions based on display image data. The system may also include image processing circuitry to generate the display image data based on multi-resolution image data of the image frame. Generating the display image data may include determining an enhancement to be applied to a portion of the multi-resolution image data and adjusting the determined enhancement to be applied to the portion of the multi-resolution image data based on boundary data associated with locations of boundaries between the regions.

### BACKGROUND

This disclosure relates to image data processing and, more specifically, enhancement of image data corresponding to a multi-resolution display, such as a foveated display.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Numerous electronic devices-including televisions, portable phones, computers, wearable devices, vehicle dashboards, virtual-reality glasses, and more-display images on an electronic display. To display an image, an electronic display may control light emission of its display pixels based at least in part on corresponding image data. In some scenarios, such as in virtual reality, mixed reality, and/or augmented reality, an image frame of the image data to be displayed may be blended from multiple sources. For example, graphics may be rendered in high definition and blended with a camera feed. Furthermore, the image data may be formatted in multiple resolutions, such as for a foveated display that displays multiple different resolutions of an image at different locations on the electronic display depending on a viewer's gaze or focal point on the display. However, in some scenarios, rendered content may be at a lower resolution than desired to be displayed, which may appear unnatural and/or inconsistent with other image data (e.g., camera feed) and lead to a reduced user experience.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates to the enhancement of image data that corresponds to multi-resolution content (e.g., foveated display content) to be displayed on an electronic display, such as a foveated display. For example, it may be desired to increase the resolution (e.g., pixel density resolution) of multi-resolution image data to provide higher-definition content for viewing. Multi-resolution image data is arranged such that different portions of the display simultaneously display content at different resolutions. For example, different resolutions may be displayed at different areas of the display based on a focal point of a viewer's gaze, such that the image content is displayed at a higher resolution towards the focal point (e.g., where a viewer's eye may have higher acuity) and a lower resolution away from the focal point (e.g., where a viewer's eye may have lower acuity). As such, adjustable regions (e.g., based on the focal point) of different size pixel groupings (e.g., resolutions) are established for each image frame identifying the content resolution for different portions of the electronic display. While not limited to such implementations, such displays may be utilized for virtual reality, mixed reality, and/or augmented reality, where the viewer's eye movement may be tracked. For example, the electronic display may be implemented as wearable glasses or goggles.

Indeed, image data in a multi-resolution format (e.g., a format having different content resolutions at different locations within a single image frame) may be used in virtual reality, mixed reality, and/or augmented reality to improve a user's experience and/or increase perceived realism. In some embodiments, content may be blended from multiple sources (e.g., camera feed, rendered graphics) to provide the virtual reality, mixed reality, and/or augmented reality experience. However, in some scenarios, it may be difficult to render high-resolution graphics/content to blend with a camera feed or other image data source in real-time (e.g., such as in virtual reality, mixed reality, and/or augmented reality) due to bandwidth and/or hardware limitations. As such, in some embodiments, image processing circuitry may reduce the resolution of the generated (e.g., rendered) graphics and perform image enhancement on the graphics image data to increase the resolution. Moreover, rendering lower-resolution graphics/content and performing enhancement thereon may increase the power efficiency of the electronic device.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is a schematic diagram of the image processing circuitry of FIG. 1 including an enhancement block, in accordance with an embodiment;

FIG. 8 is an example layout of multiple adjustable regions of pixel groupings of a foveated display, in accordance with an embodiment;

FIG. 9 is a schematic diagram of the enhancement block of FIG. 7, in accordance with an embodiment;

FIG. 10 is an example flow diagram of the enhancement block of FIG. 9, in accordance with an embodiment;

FIG. 11 is an example flow diagram for performing example-based enhancement, in accordance with an embodiment;

FIG. 12 is a depiction of sets of pixels used in calculating the example-based enhancement of FIG. 11, in accordance with an embodiment; and

FIG. 13 is an example layout of an enhancement grid overlaid with the boundaries of the adjustable regions of FIG. 8, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Electronic devices often use electronic displays to present visual information. Such electronic devices may include computers, mobile phones, portable media devices, tablets, televisions, virtual-reality headsets, and vehicle dashboards, among many others. To display an image, an electronic display controls the luminance (and, as a consequence of variation in luminance emitted by different red, green, and blue display pixels, the collective color) of its display pixels based on corresponding image data received at a particular resolution. For example, an image data source may provide image data as a stream of pixel data, in which data for each display pixel indicates a target luminance (e.g., brightness) of one or more display pixels located at corresponding pixel positions. In some embodiments, image data may indicate luminance per color component, for example, via red component image data, blue component image data, and green component image data, collectively referred to as RGB image data (e.g., RGB, sRGB). Additionally or alternatively, image data may be indicated by a luma channel and one or more chrominance channels (e.g., YCbCr, YUV), grayscale (e.g., gray level), or other color basis. It should be appreciated that a luma channel, as disclosed herein, may encompass linear, non-linear, and/or gamma-corrected luminance values.

Additionally, the image data may be processed to account for one or more physical or digital effects associated with displaying the image data. For example, image data may be enhanced to increase the resolution (e.g., pixel density resolution and/or bit-depth) of the image data. For example, in some scenarios, it may be difficult and/or less efficient to render high-resolution image data to due to bandwidth, power, and/or hardware limitations. As such, image data may be initially rendered in a lower resolution and enhanced to generate higher resolution image data.

For example, it may be desired to increase the resolution of image data to provide high-definition content in virtual reality, mixed reality, and/or augmented reality. The increased resolution may improve a user's experience and/or increase perceived realism. In some embodiments, content may be blended from multiple sources (e.g., camera feed, rendered graphics) to provide the virtual reality, mixed reality, and/or augmented reality experience. However, it may be difficult to generate high-resolution graphics to blend with a camera feed in real-time (e.g., such as in virtual reality, mixed reality, and/or augmented reality) due to bandwidth and/or hardware limitations. As such, in some embodiments, image processing circuitry may select whether to render higher-resolution graphics content directly or to render lower-resolution content and perform image enhancement on the graphics image data to increase the resolution. For example, lower-resolution content may be rendered and enhancement performed to increase power efficiency. However, image enhancement may be more complicated in the case of multi-resolution image data, such as for display on a foveated display.

In foveated displays, the image data is be arranged such that different portions of the display have different content resolutions, such as based on a focal point of a viewer's gaze. As such, fixed or adjustable (e.g., based on the focal point) regions of different size pixel groupings are established for each image frame identifying the content resolution for different portions of the electronic display. This concept is based on the fact that a user may not notice reduced resolution further from the user's focal point, as the human eye has reduced resolution capabilities (i.e., acuity) further from the focal point. As such, enhancement of graphics image data may include a full image frame or be focused in regions that the user is also focused on.

In some embodiments, enhancement is performed via an enhancement block of image processing circuitry. Such enhancement may include, but is not limited to example-based enhancement (EBE), color-tone based enhancement, chrominance transition improvement (CTI), luminance transition improvement (LTI), chroma adjustments based on the LTI, etc. Moreover, in some embodiments, boundary data indicative of the boundaries between the adjustable regions or otherwise demarcating the changes in content resolution may be used to select where and how much enhancement is performed on the graphics image data. Although discussed herein as relating to virtual reality, mixed reality, and/or augmented reality and graphics image data, as should be appreciated, the techniques discussed herein may be applicable to any suitable image data to be displayed on any suitable electronic display (e.g., an electronic display having a fixed or varying physical pixel density and/or an electronic display that applies foveation via pixel circuitry).

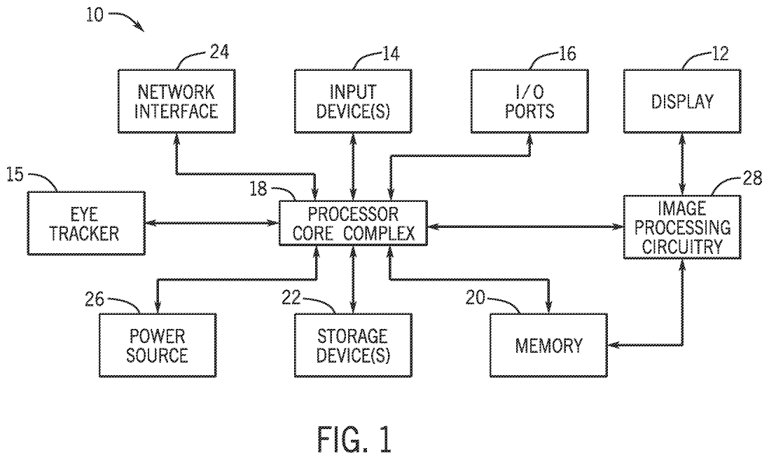

With the foregoing in mind, FIG. 1 is an example electronic device 10 with an electronic display 12 having independently controlled color component illuminators (e.g., projectors, backlights). As described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 may include one or more electronic displays 12, input devices 14, an eye tracker 15, input/output (I/O) ports 16, a processor core complex 18 having one or more processors or processor cores, local memory 20, a main memory storage device 22, a network interface 24, a power source 26, and image processing circuitry 28. The various components described in FIG. 1 may include hardware elements (e.g., circuitry), software elements (e.g., a tangible, non-transitory computer-readable medium storing instructions), or a combination of both hardware and software elements. As should be appreciated, the various components may be combined into fewer components or separated into additional components. For example, the local memory 20 and the main memory storage device 22 may be included in a single component. Moreover, the image processing circuitry 28 (e.g., a graphics processing unit, a display image processing pipeline) may be included in the processor core complex 18 or be implemented separately.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors such as reduced instruction set computing (RISC) processors, one or more application specific integrated circuits (ASICs), one or more field programmable gate arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to operate the processor core complex 18 and/or other components in the electronic device 10. Thus, the power source 26 may include any suitable source of energy, such as a rechargeable lithium polymer (Li-poly) battery and/or an alternating current (AC) power converter.

The I/O ports 16 may enable the electronic device 10 to interface with various other electronic devices. For example, when a portable storage device is connected, the I/O port 16 may enable the processor core complex 18 to communicate data with the portable storage device. Moreover, the input devices 14 may enable a user to interact with the electronic device 10. For example, the input devices 14 may include buttons, keyboards, mice, trackpads, and the like. Additionally or alternatively, the electronic display 12 may include touch sensing components that enable user inputs to the electronic device 10 by detecting occurrence and/or position of an object touching its screen (e.g., surface of the electronic display 12).

Additionally, the electronic display 12 may be a display panel with one or more display pixels. For example, the electronic display 12 may include a self-emissive pixel array having an array of one or more of self-emissive pixels or liquid crystal pixels. The electronic display 12 may include any suitable circuitry (e.g., display driver circuitry) to drive the self-emissive pixels, including for example row driver and/or column drivers (e.g., display drivers). Each of the self-emissive pixels may include any suitable light emitting element, such as an LED (e.g., an OLED or a micro-LED). However, any other suitable type of pixel, including non-self-emissive pixels (e.g., liquid crystal as used in liquid crystal displays (LCDs), digital micromirror devices (DMD) used in DMD displays) may also be used. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one color component (e.g., red, green, or blue for an RGB pixel arrangement or red, green, blue, or white for an RGBW arrangement). As used herein, a display pixel may refer to a collection of sub-pixels (e.g., red, green, and blue subpixels) or may refer to a single sub-pixel.

The eye tracker 15 may measure positions and movement of one or both eyes of someone viewing the electronic display 12 of the electronic device 10. For instance, the eye tracker 15 may include a camera that can record the movement of a viewer's eyes as the viewer looks at the electronic display 12. However, several different practices may be employed to track a viewer's eye movements. For example, different types of infrared/near infrared eye tracking techniques such as bright-pupil tracking and dark-pupil tracking may be used. In both of these types of eye tracking, infrared or near infrared light is reflected off of one or both of the eyes of the viewer to create corneal reflections. A vector between the center of the pupil of the eye and the corneal reflections may be used to determine a point on the electronic display 12 at which the viewer is looking. The processor core complex 18 may use the gaze angle(s) of the eyes of the viewer when generating/processing image data for display on the electronic display 12.

As described above, the electronic display 12 may display an image by controlling the luminance output (e.g., light emission) of the sub-pixels based on corresponding image data. In some embodiments, pixel or image data may be generated by an image source, such as the processor core complex 18, a graphics processing unit (GPU), or an image sensor (e.g., camera). Additionally, in some embodiments, image data may be received from another electronic device 10, for example, via the network interface 24 and/or an I/O port 16. Moreover, in some embodiments, the electronic device 10 may include multiple electronic displays 12 and/or may perform image processing (e.g., via the image processing circuitry 28) for one or more external electronic displays 12, such as connected via the network interface 24 and/or the I/O ports 16.

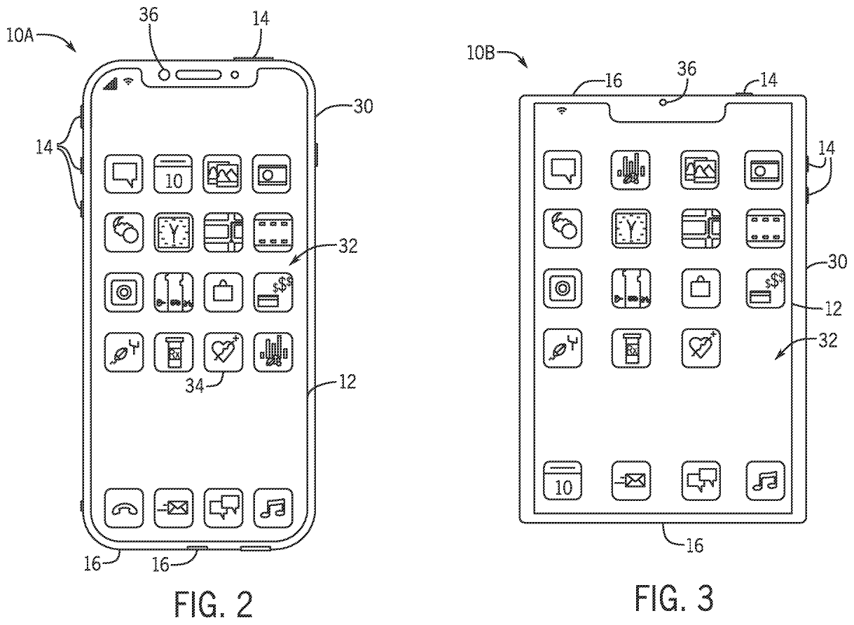

The electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For illustrative purposes, the handheld device 10A may be a smartphone, such as an IPHONE® model available from Apple Inc.

The handheld device 10A may include an enclosure 30 (e.g., housing) to, for example, protect interior components from physical damage and/or shield them from electromagnetic interference. The enclosure 30 may surround, at least partially, the electronic display 12. In the depicted embodiment, the electronic display 12 is displaying a graphical user interface (GUI) 32 having an array of icons 34. By way of example, when an icon 34 is selected either by an input device 14 or a touch-sensing component of the electronic display 12, an application program may launch.

Input devices 14 may be accessed through openings in the enclosure 30. Moreover, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. Moreover, the I/O ports 16 may also open through the enclosure 30. Additionally, the electronic device may include one or more cameras 36 to capture pictures or video. In some embodiments, a camera 36 may be used in conjunction with a virtual reality or augmented reality visualization on the electronic display 12.

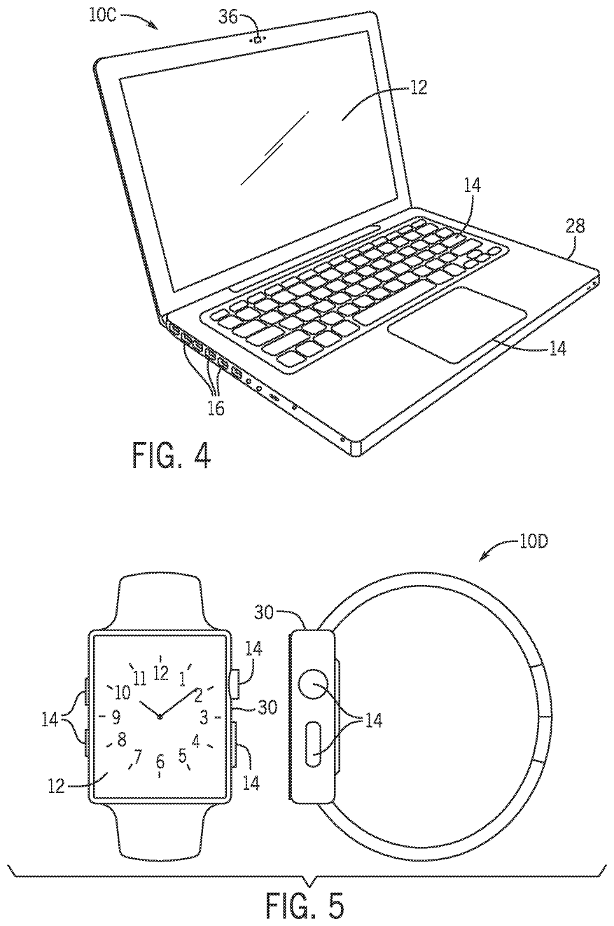

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

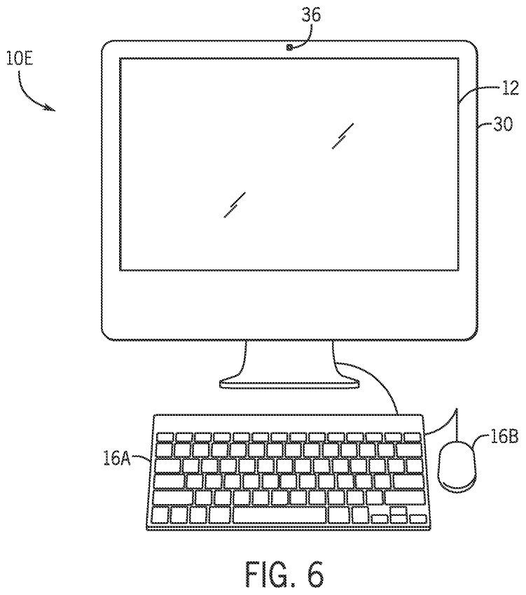

Turning to FIG. 6, a computer 10E may represent another embodiment of the electronic device 10 of FIG. 1. The computer 10E may be any suitable computer, such as a desktop computer, a server, or a notebook computer, but may also be a standalone media player or video gaming machine. By way of example, the computer 10E may be an iMac®, a MacBook®, or other similar device by Apple Inc. of Cupertino, California. It should be noted that the computer 10E may also represent a personal computer (PC) by another manufacturer. A similar enclosure 30 may be provided to protect and enclose internal components of the computer 10E, such as the electronic display 12. In certain embodiments, a user of the computer 10E may interact with the computer 10E using various peripheral input devices 14, such as a keyboard 14A or mouse 14B, which may connect to the computer 10E.

As described above, the electronic display 12 may display images based at least in part on image data. Before being used to display a corresponding image on the electronic display 12, the image data may be processed, for example, via the image processing circuitry 28. In general, the image processing circuitry 28 may process the image data for display on one or more electronic displays 12. For example, the image processing circuitry 28 may include a display pipeline, memory-to-memory scaler and rotator (MSR) circuitry, warp compensation circuitry, or additional hardware or software means for processing image data. The image data may be processed by the image processing circuitry 28 to reduce or eliminate image artifacts, compensate for one or more different software or hardware related effects, and/or format the image data for display on one or more electronic displays 12. As should be appreciated, the present techniques may be implemented in standalone circuitry, software, and/or firmware, and may be considered a part of, separate from, and/or parallel with a display pipeline or MSR circuitry.

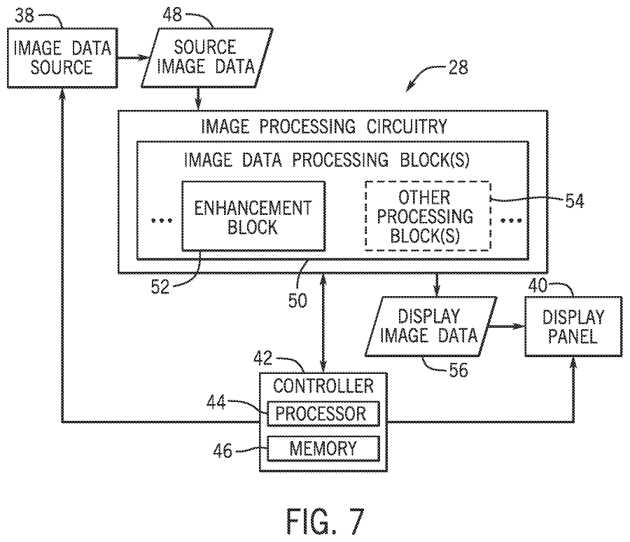

To help illustrate, a portion of the electronic device 10, including image processing circuitry 28, is shown in FIG. 7. The image processing circuitry 28 may be implemented in the electronic device 10, in the electronic display 12, or a combination thereof. For example, the image processing circuitry 28 may be included in the processor core complex 18, a timing controller (TCON) in the electronic display 12, or any combination thereof. As should be appreciated, although image processing is discussed herein as being performed via a number of image data processing blocks, embodiments may include hardware or software components to carry out the techniques discussed herein.

The electronic device 10 may also include an image data source 38, a display panel 40, and/or a controller 42 in communication with the image processing circuitry 28. In some embodiments, the display panel 40 of the electronic display 12 may be a self-emissive display panel (e.g., OLED, LED, μLED, HOLED), transmissive display panel (e.g., a liquid crystal display (LCD)), a reflective technology display panel (e.g., DMD display), or any other suitable type of display panel 40. In some embodiments, the controller 42 may control operation of the image processing circuitry 28, the image data source 38, and/or the display panel 40. The controller 42 may include a controller processor 44 and/or controller memory 46. The controller processor 44 may be any suitable microprocessor, such as a general-purpose microprocessor such as a reduced instruction set computing (RISC) processor, an application specific integrated circuit (ASIC), a field programmable gate array (FPGA), or any combination thereof. In some embodiments, the controller processor 44 may be included in the processor core complex 18, the image processing circuitry 28, a timing controller in the electronic display 12, a separate processing module, or any combination thereof and execute instructions stored in the controller memory 46. Additionally, in some embodiments, the controller memory 46 may be included in the local memory 20, the main memory storage device 22, a separate tangible, non-transitory, computer-readable medium, or any combination thereof.

The image processing circuitry 28 may receive source image data 48 corresponding to a desired image to be displayed on the electronic display 12 from the image data source 38. The source image data 48 may indicate target characteristics (e.g., pixel data) corresponding to the desired image using any suitable source format, such as an RGB format, an αRGB format, a YCbCr format, and/or the like. Moreover, the source image data may be fixed or floating point and be of any suitable bit-depth. Furthermore, the source image data 48 may reside in a linear color space, a gamma-corrected color space, or any other suitable color space. As used herein, pixels or pixel data may refer to a grouping of sub-pixels (e.g., individual color component pixels such as red, green, and blue) or the sub-pixels themselves.

As described above, the image processing circuitry 28 may operate to process source image data 48 received from the image data source 38. The image data source 38 may include captured images (e.g., from one or more cameras 36), images stored in memory, graphics generated by the processor core complex 18, or a combination thereof. Additionally, the image processing circuitry 28 may include one or more image data processing blocks 50 (e.g., circuitry, modules, or processing stages) such as an enhancement block 52. As should be appreciated, multiple other processing blocks 54 may also be incorporated into the image processing circuitry 28, such as a pixel contrast control (PCC) block, a burn-in compensation (BIC)/burn-in statistics (BIS) block, a color management block, a dither block, a blend block, a warp block, a scaling/rotation block, etc. before and/or after the enhancement block 52. The image data processing blocks 50 may receive and process source image data 48 and output display image data 56 in a format (e.g., digital format, image space, and/or resolution) interpretable by the display panel 40. For example, in the case of a foveated display (e.g., an electronic display 12 outputting multi-resolution image data), the image processing blocks 50 may output display image data 56 in the multi-resolution format.

Furthermore, the functions (e.g., operations) performed by the image processing circuitry 28 may be divided between various image data processing blocks 50, and, while the term “block” and/or “sub-block” is used herein, there may or may not be a logical or physical separation between the image data processing blocks 50 and/or sub-blocks thereof. After processing, the image processing circuitry 28 may output the display image data 56 to the display panel 40. Based at least in part on the display image data 56, the display panel 40 may apply electrical signals to the display pixels of the electronic display 12 to output desired luminances corresponding to the image.

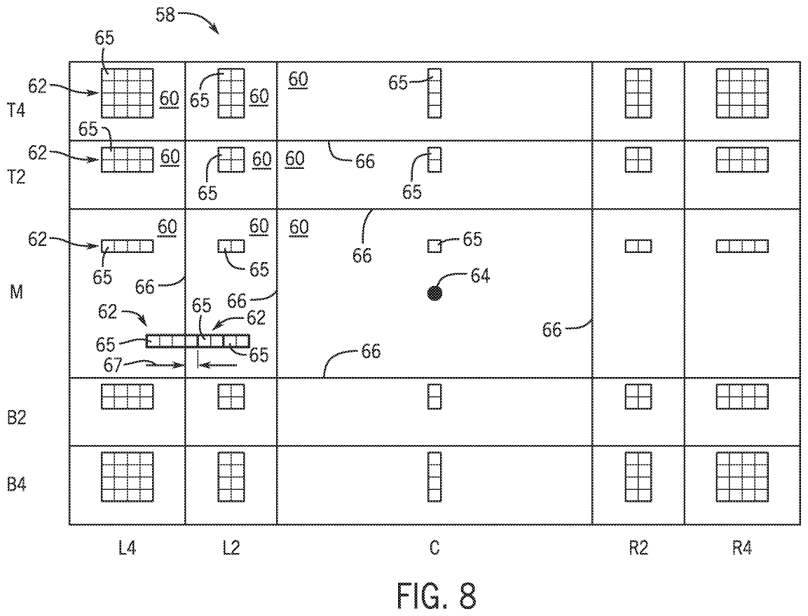

As discussed herein, in some scenarios, the display image data 56 may be output from the image processing circuitry 28 in a multi-resolution format to an electronic display 12 to be displayed in multiple resolutions. As should be appreciated, the boundaries of the regions of the multi-resolution format may be fixed or adjustable and may be based on the specifications of the electronic display 12 that receives the display image data 56 and/or based on a viewer's focal point, which may change on each image frame. To help illustrate, FIG. 8 is a foveated display 58 having multiple adjustable regions 60 of pixel groupings 62. In general, a foveated display 58 has a variable content resolution across the display panel 40 such that different portions of the display panel 40 are displayed at different resolutions depending on a focal point 64 (e.g., center of the viewer's gaze) of the user's gaze (e.g., determined by eye-tracking). By reducing the content resolution in certain portions of the display panel 40, image processing time and/or resource utilization may be reduced. While the human eye may have its best acuity at the focal point 64, further from the focal point 64, a viewer may not be able to distinguish between high and low resolutions. As such, higher content resolutions may be utilized in regions of the foveated display 58 near the focal point 64, while lesser content resolutions may be utilized further from the focal point 64. For example, if a viewer's focal point 64 is at the center of the foveated display 58, the portion of the foveated display 58 at the center may be set to have the highest content resolution (e.g., with 1×1 pixel grouping 62), and portions of the foveated display 58 further from the focal point 64 may have lower content resolutions with larger pixel groupings 62 (e.g., associated with anchor pixels 65, as discussed further below). In the example of FIG. 8, the focal point 64 is in the center of the foveated display 58 giving symmetrical adjustable regions 60. However, depending on the location of the focal point 64, the location of the boundaries 66 and the size of the adjustable regions 60 may vary.

In the depicted example, the foveated display 58 is divided into a set of 5×5 adjustable regions 60 according to their associated pixel groupings 62. In other words, five columns (e.g., L4, L2, C, R2, and R4) and five rows (e.g., T4, T2, M, B2, and B4) may define the adjustable regions 60. The center middle (C, M) adjustable region coincides with the focal point 64 of the viewer's gaze and may utilize the native resolution of the display panel 40 (e.g., 1×1 pixel grouping 62). Adjustable regions 60 in columns to the right of center (C), such as R2 and R4, have a reduced content resolution in the horizontal direction by a factor of two and four, respectively. Similarly, adjustable regions 60 in columns to the left of center, such as L2 and L4, have a reduced content resolution in the horizontal direction by a factor of two and four, respectively. Moreover, rows on top of the middle (M), such as T2 and T4, have a reduced content resolution in the vertical direction by a factor of two and four, respectively. Similarly, rows below the middle (M), such as B2 and B4, have a reduced content resolution in the vertical direction by a factor of two and four, respectively. As such, depending on the adjustable region 60, the content resolution may vary horizontally and/or vertically.

The pixel groupings 62 may be indicative of the set of display pixels that utilize the same image data in the reduced content resolutions. For example, while the adjustable region 60 at the focal point 64 may be populated by 1×1 pixel groupings 62, the adjustable region 60 in column L4 and row M may be populated by 4×1 pixel groupings 62 such that individual pixel values, processed as corresponding to individual pixel locations in the reduced content resolution, are each sent to sets of four horizontal pixels of the display panel 40. Similarly, the adjustable region 60 in column L4 and row T4 may be populated by 4×4 pixel groupings 62 such that pixel values are updated sixteen pixels at a time. As should be appreciated, while discussed herein as having reduced content resolutions by factors of two and four, any suitable content resolution or pixel groupings 62 may be used depending on implementation. Furthermore, while discussed herein as utilizing a 5×5 set of adjustable regions 60, any number of columns and rows may be utilized with additional or fewer content resolutions depending on implementation.

As the focal point 64 moves the boundaries 66 of the adjustable regions 60, and the sizes thereof, may also move. For example, if the focal point 64 were to be on the far upper right of the foveated display 58, the center middle (C, M) adjustable region 60, coinciding with the focal point 64, may be set to the far upper right of the foveated display 58. In such a scenario, the T2 and T4 rows and the R2 and R4 columns may have heights and widths of zero, respectively, and the remaining rows and columns may be expanded to encompass the foveated display 58. As such, the boundaries 66 of the adjustable regions 60 may be adjusted based on the focal point 64 to define the pixel groupings 62 for different portions of the foveated display 58.

As discussed herein, the pixel groupings 62 are blocks of pixels that receive the same image data as if the block of pixels was a single pixel in the reduced content resolution of the associated adjustable region 60. To track the pixel groupings 62, an anchor pixel 65 may be assigned for each pixel grouping 62 to denote a single pixel location that corresponds to the pixel grouping 62. For example, the anchor pixel 65 may be the top left pixel in each pixel grouping 62. The anchor pixels 65 of adjacent pixel groupings 62 within the same adjustable region 60 may be separated by the size of the pixel groupings 62 in the appropriate direction. Furthermore, in some scenarios, pixel groupings 62 may cross one or more boundaries 66. For example, an anchor pixel 65 may be in one adjustable region 60, but the remaining pixels of the pixel grouping 62 may extend into another adjustable region 60. As such, in some embodiments, an offset 67 may be set for each column and/or row to define a starting position for anchor pixels 65 of the pixel groupings 62 of the associated adjustable region 60 relative to the boundary 66 that marks the beginning (e.g., left or top side) of the adjustable region 60. For example, an anchor pixel 65 at a boundary 66 (e.g., corresponding to a pixel grouping 62 that abuts the left and/or upper boundary 66 of an adjustable region 60) may have an offset 67 of zero, while an anchor pixel 65 that is one pixel removed from the boundary 66 (e.g., one pixel to the right of or below the boundary 66) may have an offset 67 of one in the corresponding direction. As should be appreciated, while the top left pixel is exampled herein as an anchor pixel 65 and the top and left boundaries 66 are defined as the starting boundaries (e.g., in accordance with raster scan), any pixel location of the pixel grouping 62 may be used as the representative pixel location and any suitable directions may be used for boundaries 66, depending on implementation (e.g., read order).

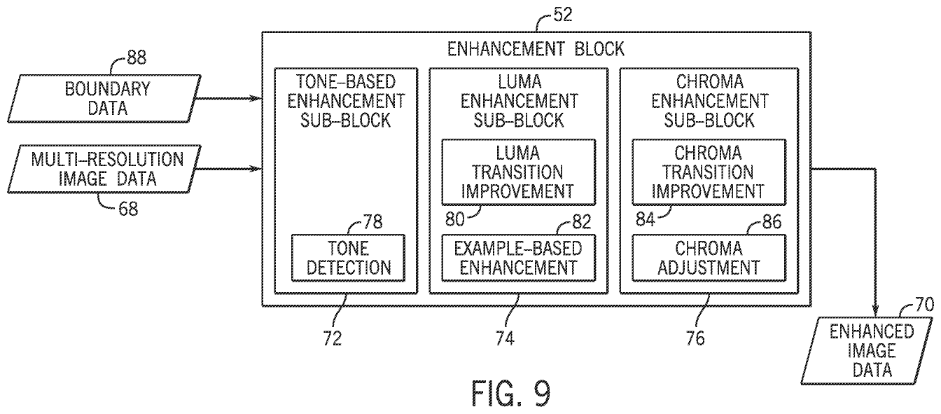

While not limited to such implementations, displays such as foveated displays 58 may be utilized for virtual reality, mixed reality, and/or augmented reality, where the viewer's eye movement may be tracked (e.g., via an eye tracker 15). Indeed, image data in a multi-resolution format (e.g., a format having different content resolutions at different locations within a single image frame) may be used in virtual reality, mixed reality, and/or augmented reality to improve a user's experience and/or increase perceived realism. In some embodiments, content may be blended from multiple sources (e.g., camera feed, rendered graphics) to provide the virtual reality, mixed reality, and/or augmented reality experience. However, in some scenarios, it may be difficult to render high-resolution graphics/content to blend with a camera feed or other image data in real-time (e.g., such as in virtual reality, mixed reality, and/or augmented reality) due to bandwidth, power, and/or hardware limitations. As such, in some embodiments, the enhancement block 52 of the image processing circuitry 28 may receive multi-resolution image data 68, perform image enhancement on the multi-resolution image data 68 to increase the resolution, and output enhanced image data 70, as shown in FIG. 9.

The enhancement block 52 alters image data to enhance edges, colors, and/or other image content to increase the perceived resolution of rendered content. Moreover, the enhancement block may include a tone-based enhancement sub-block 72, a luma enhancement sub-block 74, and/or a chrominance enhancement sub-block 76. For example, the multi-resolution image data 68 may be received in or converted to a chromatic color space (e.g., YCbCr, YPbPr, YIQ, YUV) having a luma channel and one or more chroma channels, and enhancement may be performed, at least in part, independently on the different channels of the multi-resolution image data 68. As should be appreciated, while discussed herein as operating, at least in part, in a chromatic color space, the techniques discussed herein may be applicable in any suitable color space.

In general, the tone-based enhancement sub-block 72 may perform enhancements based on tone detection 78 that identifies color tones of the multi-resolution image data 68 as potentially corresponding to particular content (e.g., the sky, skin, grass, or other content). For example, it may be desired to enhance some content more than others, and tone detection 78 may differentiate (e.g., based on probability, based on a confidence score) such content. Additionally, the luma enhancement sub-block 74 may perform enhancements to the luma channel of the multi-resolution image data 68. For example, a luma transition improvement (LTI) 80 and/or example-based enhancement (EBE) 82 may be performed on the luma channel via the luma enhancement sub-block 74. Moreover, the chrominance enhancement sub-block 76 may perform enhancement on the chroma channel(s) of the multi-resolution image data 68. For example, a chroma transition improvement (CTI) 84 and/or chroma adjustment 86 may be performed on the chroma channel(s) via the chrominance enhancement sub-block 76. As discussed above, the image processing blocks 50, such as the enhancement block 52, may be implemented in hardware and/or software, and may include circuitry (e.g., enhancement circuitry) to perform any functions of the enhancement block 52, such as the functions of the tone-based enhancement sub-block 72, the luma enhancement sub-block 74, and/or the chroma enhancement sub-block 76.

Additionally, in some embodiments, boundary data 88 indicative of the boundaries 66 between the adjustable regions 60 or otherwise demarcating the changes in content resolution (e.g., including anchor pixel offsets) may be used to select where and/or how much enhancement is performed on the multi-resolution image data 68 and/or to adjust enhancements along the boundaries 66 (e.g., to avoid or reduce perceivable artifacts caused by enhancements across different resolutions). Although discussed herein as relating to virtual reality, mixed reality, and/or augmented reality and/or graphics/blended image data, as should be appreciated, the techniques discussed herein may be applicable to any multi-resolution image data 68 to be displayed on any suitable electronic display 12 (e.g., an electronic display having a fixed or varying physical pixel density, an electronic display that applies foveation via pixel circuitry, an electronic display having no foveated-specific properties, or a foveated display 58 coupled to an eye tracker 15).

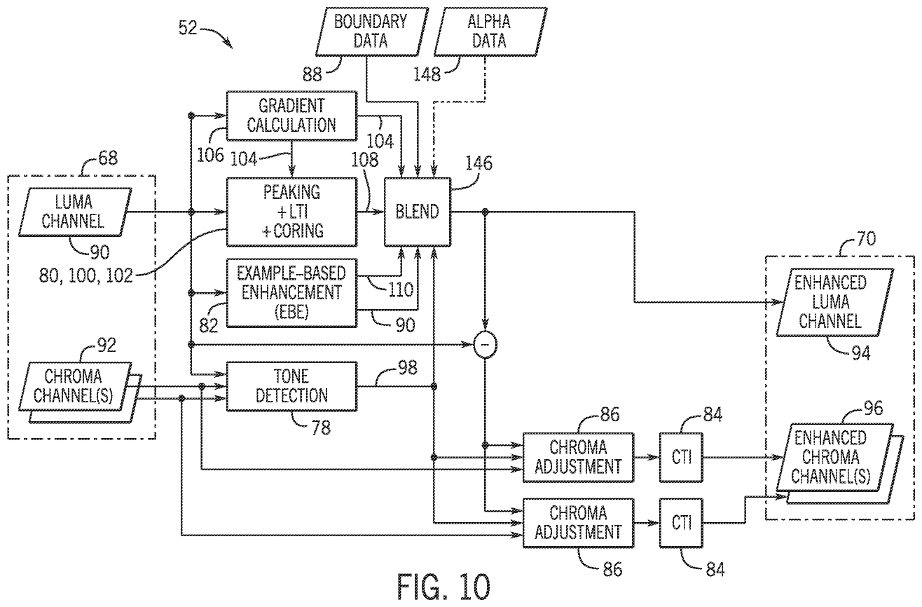

FIG. 10 is an example flow diagram of the enhancement block 52 that receives a luma channel 90 and two chroma channels 92 of the multi-resolution image data 68 and generates an enhanced luma channel 94 and two enhanced chroma channels 96 of the enhanced image data 70. As should be appreciated, the flow of the depicted sub-blocks/enhancements is shown in a given order, in certain embodiments, sub-blocks/enhancements may be reordered, deleted, merged, and/or selectively bypassed. Moreover, the flow diagram is given as an example and illustrative tool and further sub-blocks or other enhancements may also be added depending on implementation.

In the example of FIG. 10, the multi-resolution image data 68 may be used for tone detection 78. Tone detection 78 may search the image content for recognizable color tones matching possible image representations (e.g., the sky, grass, skin, or other content). In some embodiments, tone detection 78 may combine multiple color channels (e.g., the luma channel 90 and chroma channels 92) to determine if a recognizable color tone is present. For example, the multi-resolution image data 68 may be converted into an RGB color space (if desired) and then to a hue, saturation, value (HSV) format for analysis. As should be appreciated, any suitable color space may be utilized for analysis depending on implementation. Each searched color tone may also be given a confidence level based at least in part on the likelihood that the detected color tone is characteristic of the image content. The recognition of color tones within the image may lead to improved enhancement of the image by including an improved evaluation of the image content. For example, the luma enhancement sub-block 74 and chrominance enhancement sub-block 76 may use determined color tone data 98 to adjust (e.g., to increase or reduce) the amount of enhancement in the areas where the color tones were detected. For example, more enhancement may be desired in an area indicative of landscape content (e.g., sky and/or grass), and less enhancement may be desired in an area indicative of skin content (e.g., a person's face), or vice versa. In some embodiments, the effects (e.g., more or less enhancement) on areas of the different color tones may be software programmable and/or user selectable.

Additionally, in some embodiments, the luma channel 90 may have luma-specific (e.g., independent of the chroma channels 92) enhancements. For example, the luma enhancement sub-block 74 may enhance (e.g., sharpen) the luma channel 90 of the multi-resolution image data 68 via, peaking 100, coring 102, luma transition improvement 80, and/or example-based enhancement. Moreover, the example-based enhancement 82 may run in parallel or series with peaking 100, coring 102, and/or luminance transition improvement 80 as part of the luma enhancement sub-block 74. In general, the example-based enhancement 82 may yield improved identification and display of the dominant gradients within the image content, and the luma transition improvement 80 (which may include peaking 100 and/or coring 102) may improve perceived texture in the image, the combination of which, may allow for enhancement (e.g., sharpening) of the luma channel 90.

Peaking 100 may include applying one or more horizontal or vertical filters (e.g., high-pass and/or low-pass) arranged with adaptive or programmable gain logic, such as a peaking filter. The peaking filter may boost programmable ranges of frequencies corresponding to content features of the image (e.g., cross hatching, other high frequency components). The boosted frequency ranges may provide better frequency and/or spatial resolution to the luma channel 90. In some embodiments, the gains for the boosted frequencies may be based on edge metrics 104, such as calculated via a gradient calculation 106. For example, a more prevalent edge detected in the image content (e.g., via the gradient calculation 106) may lead to higher gains in enhancement than a noisy region of the image content or less prominent edge in the image content. The gradient calculation 106 may determine how the values of pixels in the vicinity of a pixel location of interest (e.g., associated with the pixel value being enhanced) are changing. For example, a set of 3×3 pixel values, 5×5 values, or other pixel grouping around (and including) the pixel location of interest may be analyzed to determine a likelihood and/or severity of an edge present in the image content at or near (e.g., within the pixel grouping) the pixel location of interest to adjust the gains of the enhancement. Additionally, or alternatively, a fixed (e.g., programmable or preset) gain may be used (e.g., selectively) instead of being based on the edge metrics 104.

Additionally, coring 102 may be utilized to reduce the amount of luma enhancement in noisy areas (e.g., areas not having a dominant frequency component) of the multi-resolution image data 68. For example, coring 102 may occur after peaking to reduce the enhancement generated by the peaking 100. Furthermore, the luma transition improvement 80 may use the edge metrics 104 to reduce overshoot and/or undershoots that may occur near edge transitions (e.g., edges in the image content), due to the boosted frequency ranges. For example, the luma transition improvement 80 may limit the enhancement of the peaking 100 and/or coring 102 from exceeding (plus or minus an optional offset) the maximum luma value of the pixel grouping of the edge metrics 104 and/or dropping below (plus or minus an optional offset) the minimum luma value of the pixel grouping of the edge metrics 104. As such, in some embodiments, the peaking 100, coring 102, and/or the luma transition improvement 80 may be implemented together. Moreover, in some scenarios, peaking 100 and coring 102 may be considered part of the luma transition improvement 80. Peaking 100, coring 102, and/or luma transition improvement 80 may yield enhancement data 108 indicative of an enhanced value of the luma channel 90 or a change (e.g., offset, multiplier) therefrom.

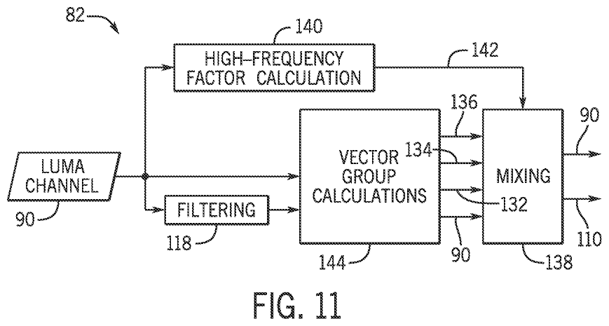

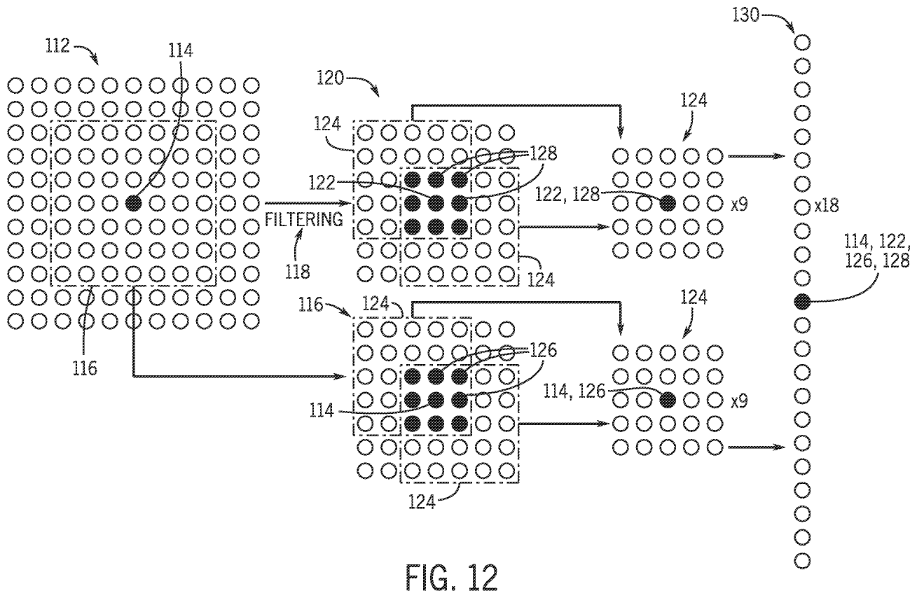

Additionally or alternatively, the luma channel 90 may undergo an example-based enhancement 82 to generate EBE data 110 indicative of an enhanced value of the luma channel 90 or a change (e.g., offset, multiplier) therefrom. For example, example-based enhancement 82 may compare one or more pixel values of the multi-resolution image data 68 to that of an altered sampling thereof to visually sharpen gradients in the image content. To help illustrate, FIG. 11 is an example flow diagram for performing example-based enhancement 82, and FIG. 12 is a depiction of sets of pixels used in calculating the example-based enhancement 82.

In some embodiments, a set of pixels 112 surrounding a pixel of interest 114 may be used to calculate the EBE data 110 for the pixel of interest 114. The set of pixels 112 may include a pixel group 116 centered around the pixel of interest 114. In order to derive an altered sampling of the multi-resolution image data 68 (e.g., the luma channel 90 thereof) filtering of the set of pixels 112 may be performed to generate a filtered pixel group 120 of the same size as the pixel group 116 and centered around a filtered pixel of interest 122. For example, the filtered pixel group 120 may be generated by low-pass filtering of the set of pixels 112. In the depicted example, a 7×7 pixel group 116 is utilized and an 11x11 set of pixels 112 is filtered 118 to generate a 7×7 filtered pixel group 120. As should be appreciated, the pixel groupings discussed herein are given as examples, and any suitable size or number of pixels may be analyzed as part of the example-based enhancement 82 of a pixel of interest 114.

In some embodiments, the pixel group 116 and filtered pixel group 120 may be divided into multiple pixel subsets 124 centered at the pixel of interest 114 and filtered pixel of interest 122, respectively, as well as the surrounding pixels 126 proximate the pixel of interest 114 and the filtered surrounding pixels 128 proximate the filtered pixel of interest 122, respectively. In the depicted example, each of the eight surrounding pixels 126 around the pixel of interest 114 and eight filtered surrounding pixels 128 around the filtered pixel of interest 122 are centers of 5×5 pixel subsets such that nine pixel subsets 124 are generated from the pixel group 116 and nine pixel subsets 124 are generated from the filtered pixel group 120. In some embodiments, the pixel subsets 124 may be represented as vector groups 130 for ease of manipulation. Moreover, while discussed herein in terms of the vector groups 130, any suitable construct may be utilized for calculations thereon.

The vector groups 130 may be used to calculate a weighted luma average 132 for the pixel position of the pixel of interest 114, a weighted filtered luma average 134 for the pixel position of the filtered pixel of interest 122, and a delta 136 therebetween. The delta 136 may be indicative of the extent of the high frequency changes (e.g., high frequency component) at and/or around the pixel of interest 114 in the multi-resolution image data 68. Moreover, the weights of the weighted luma average 132 and the weighted filtered luma average 134 may be dynamically adjusted based on the differences between the pixel subsets 124 of the surrounding pixels 126 and the pixel subset 124 of the pixel of interest 114 and the differences between the pixel subsets 124 of the filtered surrounding pixels 128 and the pixel subset 124 of the filtered pixel of interest 122, respectively. For example, the weighted luma average 132 may be a weighted average of the pixel of interest 114 and the surrounding pixels 126, and the weighting for a particular surrounding pixel 126 in the weighted average may be determined based on an aggregate difference (e.g., sum of absolute differences (SAD), sum of square differences, squared difference approximation, or other measure of differences) between the pixel subset 124 of the particular surrounding pixel 126 and the pixel subset 124 of the pixel of interest 114. Moreover, if the aggregate difference is smaller, the surrounding pixel 126 may be given a higher weight (e.g., as being more representative of the pixel of interest 114) in the weighted average, and if the aggregate difference is higher, the surrounding pixel 126 may be given less weight in the weighted average. Moreover, the weighted filtered luma average 134 may be similarly calculated based on a weighted average of the filtered pixel of interest 122 and the filtered surrounding pixels 128.

The weighted luma average 132, the weighted filtered luma average 134, and the delta 136 therebetween may be used (e.g., via mixing 138) to calculate the EBE data 110. For example, the EBE data 110 may be representative of an enhancement offset from the value of the luma channel 90 for the pixel of interest 114. In such an embodiment, the EBE data 110 may be calculated as a linear combination of the value of the luma channel 90 for the pixel of interest 114, the weighted luma average 132, the weighted filtered luma average 134, and/or the delta 136. Furthermore, high frequency factor calculations 140 may be performed on the luma channel 90 (e.g., using pixel values of the set of pixels 112, pixel group 116, pixel subset 124 centered about the pixel of interest 114, or other pixel grouping including the pixel of interest 114) to calculate coefficients 142 for use in the mixing 138 (e.g., coefficients 142 for the linear combination) the results of the vector group calculations 144 (e.g., the weighted luma average 132, the weighted filtered luma average 134, and the delta 136). Such coefficients 142 may weight the effects of the high frequency aspects (e.g., based on the delta 136) and more detailed texture aspects (e.g., based on a difference between the value of the luma channel 90 for the pixel of interest 114 and the weighted filtered luma average 134).

Returning to FIG. 10, the different luma enhancements (e.g., enhancement data 108, EBE data 110, and/or edge metrics 104) of the luma enhancement sub-block 74 and/or tone enhancement (e.g., color tone data 98) of the tone based enhancement sub-block 72 as well as the value of the luma channel 90 for the pixel of interest 114 may be blended 146 (e.g., via blend circuitry) to generate the enhanced luma channel 94 of the enhanced image data 70. For example, enhancements to the luma channel 90 from the enhancement data 108 and the EBE data 110 may be summed to generate a combined enhancement. Moreover, the edge metrics 104 and/or color tone data 98 may be used to determine factors (e.g., via one or more look-up tables (LUTs)) to augment the amount of enhancement of the enhancement data 108, EBE data 110, and/or the combined enhancement.

Furthermore, in some scenarios, blending 146 (e.g., via blend circuitry) may also include adjustments to the combined amount of enhancement (e.g., gain, offset, or other alteration to pixel value(s)) based on alpha data 148 indicative of how different portions of the graphics image data are to be overlaid or combined (e.g., summed) with other image data (e.g., captured image data via a camera 36) such as via transparency (e.g., alpha) information. For example, in some scenarios, alpha data 148 may include negative values such as to enable shading when blended with other image data. The alpha data 148 may represent which portion of the graphics image data and/or how the graphics image data is summed with the other image data. However, in some scenarios, depending on the pixel value of the alpha data 148, the enhancement to be performed on the luma channel 90 may be decreased. For example, in some scenarios, if the alpha data 148 includes negative values, enhancement may be precluded, such as to avoid over darkening of intended shadows or other effects. Moreover, lower values of alpha data 148 may reduce overall enhancement (e.g., according to a LUT or other calculation).

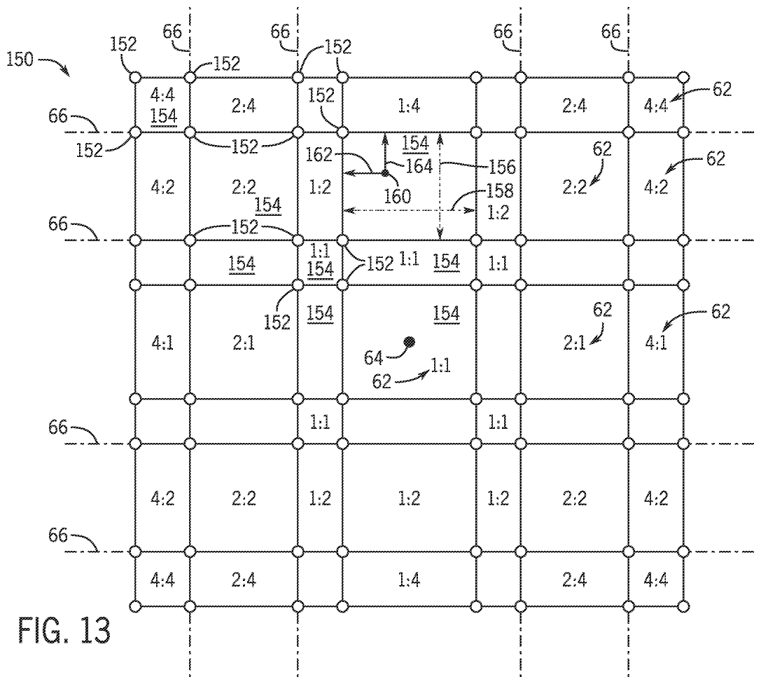

Additionally, blending 146 may include a region-based adjustment based on the boundary data 88. For example, an enhancement grid 150 may define an amount of enhancement scaling (e.g., enhancement gain) based on location relative to the boundaries 66 of the adjustable regions 60, as shown in FIG. 13. The enhancement grid 150 includes multiple enhancement grid points 152 that define enhancement zones 154. Moreover, enhancement zones 154 in higher resolution adjustable regions 60 (e.g., closer to the focal point 64) may have increased or maintained (e.g., according to the blended enhancement) enhancement, and enhancement zones 154 corresponding to lower resolution adjustable regions 60 (e.g., further from the focal point 64) may have decreased enhancement. In some embodiments, enhancement zones 154 may correspond, at least in part, to the adjustable regions 60 and the enhancement grid points 152 may be aligned with the boundaries 66. However, as should be appreciated, the enhancement grid points 152 may be disposed at any locations with any adjustable heights 156 and widths 158, based on the boundary data 88. For example, the heights 156 and widths 158 of the enhancement grid points 152 may scale with the boundaries 66 of the adjustable regions 60, but may or may not be aligned with the boundaries 66. Furthermore, the enhancement grid points 152 may define more, fewer, or the same number of enhancement zones 154 as adjustable regions 60. In the example of FIG. 13, the 1×1 adjustable region 60 may be divided into multiple enhancement zones 154, and the other adjustable regions may have corresponding enhancement zones 154.

Additionally, in some embodiments, the scaling of the enhancement may be constant or vary across the enhancement zones 154. For example, in some embodiments, the enhancement grid points 152 may define enhancement scaling factors and the amount of enhancement scaling at a particular pixel location 160 may depend on an x-distance 162 and y-distance 164 from the enhancement grid such that the enhancement scaling at the particular pixel location 160 is an interpolation (e.g., bilinear interpolation) of the enhancement scaling factors of the enhancement grid points 152 defining the applicable enhancement zone 154. By using interpolation within the enhancement grid 150, a smooth gradient of enhancement scaling may occur from the highest resolution adjustable region 60 (e.g., at the center of and/or focal point 64 on the electronic display 12) to the outer adjustable regions 60. In the depicted example, each enhancement grid point 152 of the central enhancement zone 154 (e.g., the enhancement zone 154 including the center of and/or focal point 64 on the electronic display 12) has the same enhancement scaling factor such that enhancement of the central enhancement zone 154 is uniform, and enhancement grid points 152 radially outward from the central enhancement zone 154 may have decreasing enhancement scaling factors. Indeed, enhancement zones 154 furthest from the central enhancement zone 154 may have reduced or no enhancement. While the enhancement grid points 152 are discussed herein as based on the boundary data 88 indicative of the locations of the boundaries 66 of the adjustable regions 60, as should be appreciated, such boundary data 88 may include any suitable information related thereto (e.g., used to derive the locations of the boundaries 66 or derived therefrom) such as the location of the focal point 64 and/or a center of the electronic display 12.

As discussed above, blending 146 may combine calculated enhancements and scale the enhancements based on pixel location, according to the boundary data 88 to generate the enhanced luma channel 94. Returning to FIG. 10, in some embodiments, the chroma enhancements of the chroma enhancement sub-block 76 may be based, at least in part, on the enhanced luma channel 94. For example, stronger enhancement of the luma channel 90 may lead to more noticeable changes in image saturation. As such, the chroma channels 92 may undergo a chroma adjustment 86 based on the enhancement to the luma channel 90 to compensate for the change in saturation. In other words, increased luma channel enhancement may lead to increased chroma adjustment 86 and enhancement of the chroma channels 92. Additionally, by adjusting the chroma channels 92 based on the enhanced luma channel 94, the chroma channels 92 may benefit from the boundary-data-based enhancement scaling of the enhanced luma channel 94.

Furthermore, similar to the luma transition improvement 80, the chroma enhancement sub-block 76 may include a chroma transition improvement 84, which may include peaking 100 and/or coring 102. As discussed above, if the luma channel 90 is enhanced without compensating the chrominance channel(s), the image may appear over or under saturated. As such, the chroma transition improvement 84 may employ the change in the luma channel 90 in determining the change from the chroma transition improvement 84. Additionally or alternatively, the chroma adjustment 86 and/or chroma transition improvement 84 may be disabled if, for example, there is little (e.g., below a threshold amount) or no luma channel enhancement. Together, the enhanced luma channel 94 and enhanced chroma channels 96 form the enhanced image data 70. As output from the image enhancement block 52, the enhanced image data 70 may represent a sharpened and/or more vibrant image.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

What is claimed is:

1. A system comprising:
an electronic display comprising a plurality of pixels and configured to display an image frame, the image frame having a plurality of resolutions based on display image data, wherein the image frame is divided into a plurality of regions having respective resolutions of the plurality of resolutions; and
image processing circuitry configured to generate the display image data based on multi-resolution image data of the image frame, wherein generating the display image data comprises:
determining an enhancement to be applied to a portion of the multi-resolution image data; and
adjusting the enhancement to be applied to the portion of the multi-resolution image data based on boundary data associated with locations of boundaries between the plurality of regions.

2. The system of claim 1, wherein generating the display image data comprises:
applying the adjusted enhancement to the portion of the multi-resolution image data to generate enhanced image data; and
blending the enhanced image data and additional image data of the image frame.

3. The system of claim 2, wherein the additional image data comprises captured image data and the multi-resolution image data comprises rendered graphics image data.

4. The system of claim 1, wherein determining the enhancement to be applied to the portion of the multi-resolution image data comprises performing an example-based enhancement, wherein performing the example-based enhancement for a pixel value of the portion of the multi-resolution image data comprises performing a comparison of a first pixel group comprising a first plurality of pixel values including the pixel value and a second pixel group comprising a second plurality of pixel values corresponding to same pixel position of the first plurality of pixel values, wherein the second plurality of pixel values are generated based at least in part on filtering of the first plurality of pixel values.

5. The system of claim 4, wherein the comparison comprises a difference between a first weighted average of a first subset of the first plurality of pixel values of the first pixel group and a second weighted average of a second subset of the second plurality of pixel values of the second pixel group.

6. The system of claim 1, wherein the enhancement to be applied to a pixel value of a channel of the portion of the multi-resolution image data comprises an increase or a decrease to the pixel value.

7. The system of claim 1, wherein adjusting the enhancement to be applied to a pixel value of the portion of the multi-resolution image data comprises interpolating an enhancement factor for the pixel value from a plurality of enhancement scaling factors and applying the enhancement factor to the enhancement to be applied to the pixel value.

8. The system of claim 7, wherein the plurality of enhancement scaling factors corresponds to a plurality of enhancement grid points disposed at corresponding grid point positions relative to the image frame, the corresponding grid point positions based on the boundary data, wherein interpolation of the enhancement factor is based on a pixel location of the pixel value in relation to the corresponding grid point positions.

9. The system of claim 1, wherein the multi-resolution image data comprises a chromatic color space format comprising a luma channel, and wherein determining the enhancement to be applied to the portion of the multi-resolution image data comprises determining a value change for a pixel value of the luma channel of the portion of the multi-resolution image data.

10. The system of claim 1, wherein determining the enhancement to be applied to the portion of the multi-resolution image data comprises applying one or more peaking filters to a luma channel of the portion of the multi-resolution image data.

11. The system of claim 1, wherein a center region of the plurality of regions is centered about a focal point of a user eye gaze on the electronic display, wherein the locations of the boundaries between the plurality of regions are adjustable and based on the focal point.

12. Image processing circuitry comprising:
enhancement circuitry configured to generate enhancement data indicative of gains to be applied to corresponding pixel values of an image frame of multi-resolution image data, wherein the image frame is divided into a plurality of regions having respective resolutions of a plurality of resolutions; and
blend circuitry configured to adjust the enhancement data based on boundary data associated with locations of boundaries between the plurality of regions.

13. The image processing circuitry of claim 12, wherein the blend circuitry is configured to adjust the enhancement data for a pixel of interest based on a pixel location of the pixel relative to an enhancement grid, wherein grid point positions of the enhancement grid are based on the boundary data.

14. The image processing circuitry of claim 13, wherein adjusting the enhancement data for the pixel of interest comprises:
interpolating an enhancement factor for the pixel of interest from a first subset of a plurality of enhancement scaling factors, wherein the plurality of enhancement scaling factors corresponds to a second subset of a plurality of enhancement grid points of the enhancement grid; and
applying the enhancement factor to the enhancement data for the pixel of interest.

15. The image processing circuitry of claim 14, wherein enhancement grid points of the plurality of enhancement grid points further from a reference point correspond to lower enhancement scaling factors of the plurality of enhancement scaling factors.

16. The image processing circuitry of claim 15, wherein the boundary data is based on the reference point, and wherein the reference point corresponds to a user eye gaze relative to an electronic display.

17. A non-transitory machine-readable medium comprising instructions, wherein, when executed by one or more processors, the instructions cause the one or more processors to perform operations or to control image processing circuitry to perform the operations, wherein the operations comprise:
determining boundary data associated with locations of boundaries between a plurality of regions that define areas of different content resolutions of an image frame of multi-resolution image data;
determining an enhancement to be applied to a portion of the multi-resolution image data; and
adjusting the enhancement to be applied to the portion of the multi-resolution image data based on the boundary data.

18. The non-transitory machine-readable medium of claim 17, wherein determining the enhancement to be applied comprises performing a tone-based enhancement, wherein the tone-based enhancement comprises correlating a color tone of the portion of the multi-resolution image data with a type of image content of a plurality of types of image content.

19. The non-transitory machine-readable medium of claim 18, wherein different types of image content of the plurality of types of image content are associated with different enhancements.

20. The non-transitory machine-readable medium of claim 17, wherein the operations comprise adjusting the enhancement to be applied based on values of alpha data indicative of how different portions of the multi-resolution image data are to be combined with other image data.
